(19) United States
(12) Patent Application Publication
(10) Pub. No.: US 2002/0004854 A1
(43) Pub. Date: Jan. 10, 2002

(54) Computer systems

(76) Inventor: Peter Darren Hartley, Cambridge (GB)

Correspondence Address: FLYNN, THIEL, BOUTELL & TANIS, P.C., 2026 Rambling Road, Kalamazoo, MI, 49008-1699, US

(21) Appl. No.: 09/844,750

(22) Filed: Apr. 26, 2001

(30) Foreign Application Priority Data
Apr. 26, 2000 (GB) 0010185.7

(51) Int. Cl. G06F 9/00; G06F 9/46

(52) U.S. Cl. 709/328

(57) ABSTRACT

A computer system comprising hardware (70), an operating system (68), and application programs (54) which makes function calls on the operating system, includes a portability layer (60) which directs the calls to components of a native library (62) associated with the operating system, if such components exist, or otherwise directs the calls to components of a special portability library (64). In this way the application can very easily be adapted or ported to run on many different platforms including either a feature-rich operating system or a feature-sparse operating system.

### BACKGROUND OF THE INVENTION

This invention relates to computer systems.

Existing software application programs, such as web browsers, e-mail clients, and electronic programme guides for example, are frequently written so as to be capable of being executed on a number of different target platforms. The characteristics of the target platforms vary, due for example to the use of different processors, different operating systems, or different hardware such as display devices.

In order to adapt such application software to run on a new target platform it has been necessary to review and amend the software thoroughly. This requires:

(a) locating and addressing all aspects of the software code that are specific to a particular processor;

(b) locating and addressing all aspects of the software code that are specific to a particular operating system; and

(c) locating and addressing all aspects of the program that are specific to a particular visual product styling.

The “addressing” operation here referred to can be performed as follows. Each time a new processor, operating system or visual product styling is encountered, the source code is extended so as to include variants of those sections of the code that are specific to the target platform. This type of extension may use a technique called “conditional compilation”. In this technique, the compiler choses one alternative from a number of options within the application program source code and generates program instructions in accordance with the chosen option. However, this rapidly leads to unwieldy code that is difficult to maintain and test.

FIG. 1 shows a known type of system which is designed for use with a so-called feature-rich platform, namely one which includes features such as font rendering, window management, and a widget set, whether in the operating system itself or in native libraries. The term widget set is a term used by those in the art to describe a collection of interface or display components defining, for example, how a button will look on the computer display device. The system 10 therefore comprises an application program 12 which is connected to a portability layer 16. The portability layer 16 uses a native layer 18 associated with the operating system 20 which runs on specified hardware 22 incorporating a particular processor for example. A frame buffer 24 is also accessible to the operating system 20 and to the native library 18 and provides a display memory. This system maps application requests and commands directly to the operating system associated facilities or features as determined by the native portability library 18. The terms ‘portability layer’ and ‘native library’ are well-known to those in the art.

FIG. 2 shows another known type of system which is designed for use with a so-called feature-sparse platform, namely one in which features such as font rendering, window management, and a widget set are not present. The system 30 therefore comprises an application program 32 which is connected to a portability layer 36. The portability layer 36 uses an application-provided portability library 38 which is associated with the application program 32, in contrast to the native library 18 of FIG. 1 which is associated with the operating system. The application provided portability layer 38 is coupled to a frame buffer 40 which is in turn coupled to the operating system 42 running on hardware 44.

The system 30 of FIG. 2 always maps to the application-provided portability library's own facilities or features.

The above approaches tie together the product styling, core application, and target-specific aspects This makes it impossible to develop product styling prior to execution on the target platform The known approaches thus suffer from the disadvantages that adapting the core application to a new target platform is an involved and time-consuming process, and that a particular visual product styling can only be executed on a specific target platform.

### SUMMARY OF THE INVENTION

The invention is defined in the independent claims below to which reference should now be made. Advantageous features are set forth in the appendant claims.

A preferred embodiment of the invention is described in more detail below and takes the form of a computer system comprising hardware, an operating system, and application programs which makes function calls on the operating system, and which includes a portability layer which directs the calls to components of a native library associated with the operating system, if such components exist, or otherwise directs the calls to components of a special portability library. In this way the application can very easily be adapted or ported to run on either a feature-rich platform or a feature-sparse platform, that is a platform with a feature-rich or feature-sparse operating system, respectively.

### BRIEF DESCRIPTION OF THE DRAWINGS

The invention will be described in more detail by way of example with reference to the accompanying drawings, in which:

FIG. 1 (described above) is a block schematic diagram showing the architecture of a first known computer system;

FIG. 2 (described above) is a block schematic diagram showing the architecture of a second known computer system;

FIG. 3 is a block schematic diagram showing the architecture of a preferred computer system embodying the invention when being adapted for a particular environment;

FIG. 4 is a block schematic diagram showing the architecture of a preferred computer system embodying the invention when a given application program is running; and

FIG. 5 shows the portability library of the computer system of FIG. 4 in more detail.

### DETAILED DESCRIPTION OF THE PREFERRED EMBODIMENTS

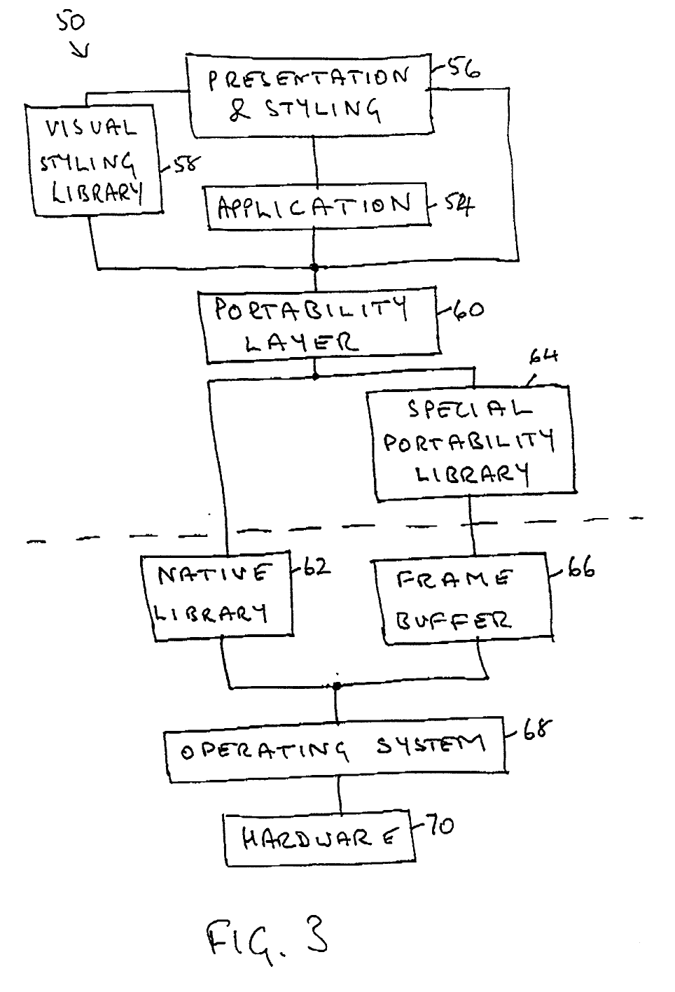

A preferred computer system will now be described with reference to FIG. 3, which illustrates the system architecture.

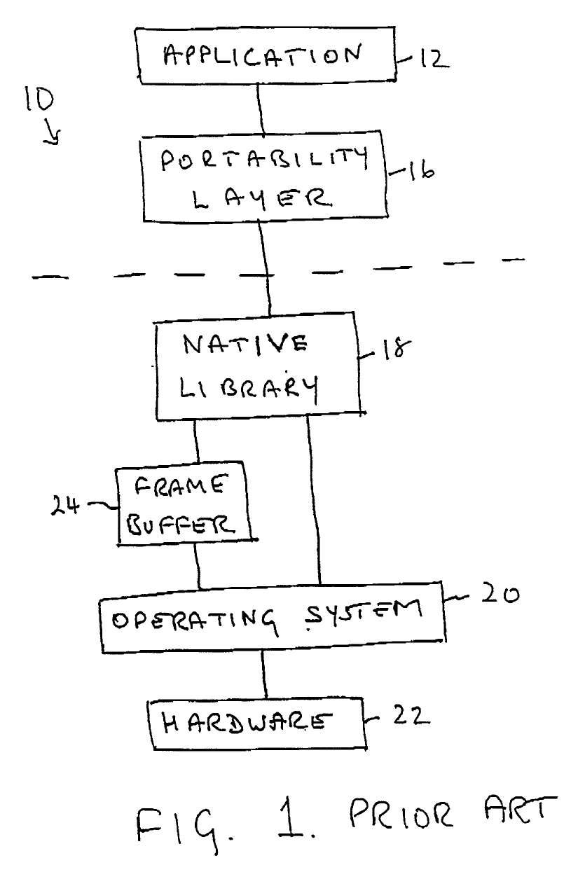

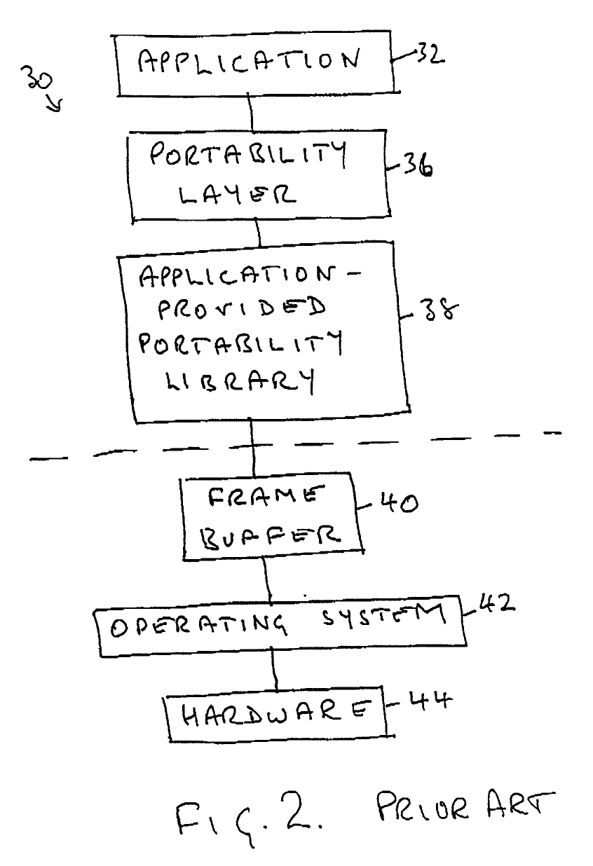

The computer system 50 comprises an application program 54 coupled to a presentation and styling section 56. The presentation and styling section is also coupled to a visual styling library 58, and a portability layer 60 communicates with the application program 54, the presentation and styling section 56, and the visual styling library 58. The visual styling library provides facilities for the graphical appearance of different elements, such as buttons, toolbars, dialog boxes, and windows, apart, of course, from their content, while the presentation and styling section 56 defines which of the available facilities are currently being used. The portability layer 60 selectively communicates with two libraries. The first is a native library 62 which is associated with the operating system and corresponds with the native library 18 in FIG. 1. The second is a special portability library 64 which is associated with the application program and broadly corresponds with the application-provided portability library 38 of FIG. 2. The special portability library 64 is coupled to a frame buffer 66.

The operating system 68 thus communicates with the native library 62 and through the frame buffer 66 with the special portability library 64. The hardware 70 is also shown in FIG. 3.

In setting up the system of FIG. 3 for operation in a particular environment, the programmer selects features from the native library 62 and special portability library 64. That is to say, for some features the portability layer 60 will map calls to the native library 62 and for other features the portability layer will map calls to the special portability library 64. By using a dynamic combination of features, maximum flexibility is provided to the programmer to set the system up very easily for any given operating system and hardware platform.

The application 54 and the user interface, including the presentation and styling section 56, positioned above the portability layer 60, are not aware of where particular facilities come from.

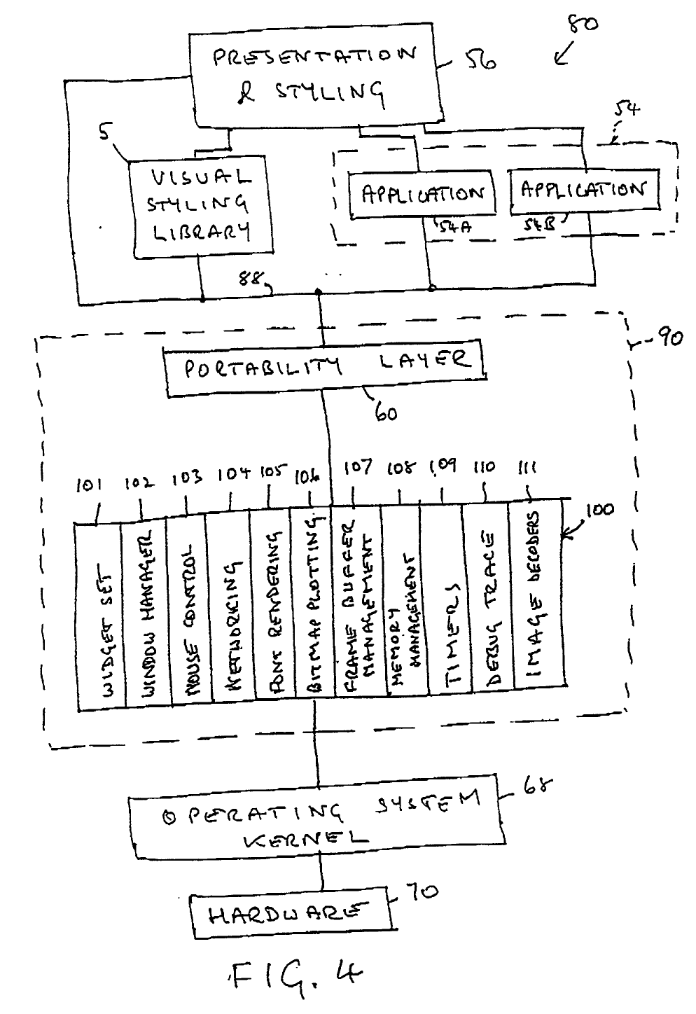

FIG. 4 shows a completed implementation of the computer system when the application program is in use. The computer system 90 illustrated includes an application core 54 which in this case comprises two application programs, namely a web browser 54A and an e-mail client 54B. To the application core is connected a presentation and styling section 56, constituting a graphics user interface (GUI). A visual styling library 58 is also connected to the presentation and styling section 56.

A portability library 90 is coupled to the application core 54, the visual styling library 58, and the presentation and styling section 56 by what may conveniently be referred to as a bus 88. The portability library 90 consists of a portability layer 60 and a plurality of portability library components, collectively referenced 100.

The portability layer 60 acts as a multiplexer and transmits calls from the application program 54 to the portability library components 100. The portability library components 100 comprise different sections for the different types of function call which may be received as described below The portability library communicates with the operating system 6B which runs on hardware 70.

The above description has been given as though the various components were separate hardware components but it will be appreciated by those skilled in the art that they, in fact, take the form of software components or modules and expressions such as “bus” should be construed accordingly.

The various components of the architecture will now be described in more detail.

The presentation and styling section 56 defines the appearance or visual “look” of the application program, that is the manner of visual presentation of buttons, entry fields, user dialogues, and other items of presentation and program logic associated with the visual user interface styling and the operation of the particular application. The presentation and styling section 56 communicates with the application core 54 from which it receives program instructions, with the visual styling library 58 on which it makes calls to obtain elements to be displayed, and with the portability layer 60, via which it receives hardware and operating system specific information and parameters, as interpreted by the portability library components 100.

The application core 54 is the basic program which is to be adapted to different target platforms and, as noted above, may be an Internet web browser, an e-mail client for reading or writing e-mail, or a program for viewing details of forthcoming television programmes, for example. The application program will from time to time make calls on the operating system software and sends instructions to the presentation and styling section 56 to cause it to display the output of the application program.

The visual styling library 58 is a portable component which comprises a collection of mechanisms or elements that are useful in implementing and realizing desired visual product styling. It is portable in the sense that it can be moved from one platform to another without modification of the source code.

The portability layer 60 provides a consistent interface to the application core 54, presentation and styling section 56, and visual styling library 58, regardless of changes in platform. More particularly the portability layer 60 receives non-platform specific operation requests from the application core 54, presentation and styling section 56, and library 58, over the “bus” 88, and forwards them to the portability library 100.

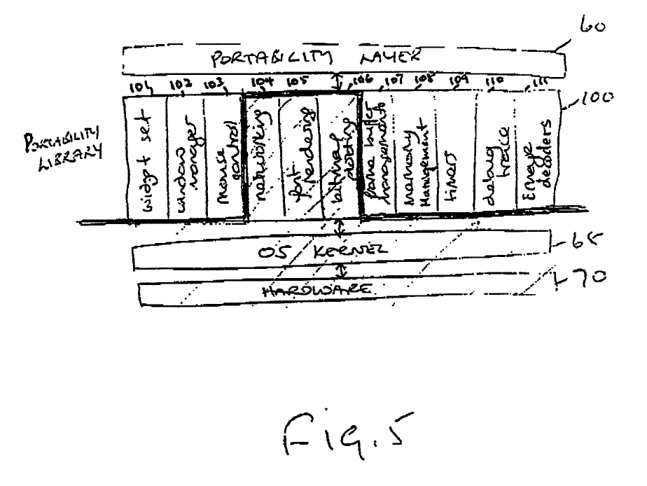

FIG. 5 shows an example of how the portability library of FIG. 4 is assembled and generated from the system of FIG. 3. In this example the portability library 100 comprises some functions derived from the native library 62 and other functions derived from the special portability library 64. In the example shown in FIG. 5 there are the following functions:

101 Widget set

102 Window manager

103 Mouse control

104 Networking

105 Font rendering

106 Bitmap plotting

107 Frame buffer management

108 Memory management

109 Timers

110 Debug trace

111 Image decoders

It will be appreciated that this list is purely exemplary and includes only a representative sample of the many functions which could be used.

As shown in FIG. 5, of these eleven features, three, namely networking 104, font rendering 105 and bitmap plotting 106 are derived from the native library 62. The rest are all derived from the special portability library 64, as shown in FIG. 3.

For different applications and different platforms the mix of functions and which of the libraries 62,64 they are derived from will be different. In general the portability library components will be taken from the native library 62 where the components exist in that library. However, where it is impossible, impracticable or undesirable to provide the feature from the native library 62, then the feature or function will be provided from the special portability library 64. In practice the whole special portability library 64 will remain present and the portability layer 60 acts as a multiplexer to direct a function call from the application 54 either to the native library 62 or from the special portability library 64 as appropriate for that particular function.

The portability library components 100 take operation requests from the portability layer 60 and implement them using the capabilities of the specific target platform, that is the hardware and operating system 68,70. The portability library components 100 can also make callback requests to the portability layer 60, which in turn passes them on to the presentation and styling section 56, application core 54, or visual styling library 58, as appropriate. Such requests may be to perform operations such as screen update, respond to mouse and keyboard, input and event timing, and network activity.

The portability library 90 takes operation requests from the presentation and styling section 56, application core 54, or visual styling library 58, which are in a generic (portable) or non-system-specific format and implements them with the capabilities of the target platform being used. Conversely, the implementation sections receive ‘callback’ requests in a target-specific format and pass them up in a non-system-specific format. The presentation and styling section 56, application core 54, and visual styling library 58, do not perform any target-specific operations. Instead they issue requests to the portability layer 60 to have generic operations performed by the target platform. The portability layer 60 arranges for the portability library components 100 to perform operations requested by the presentation and styling section 56, application core 54, or visual styling library 58. The portability library utilises the specific capabilities of the target platform to perform the operations requested of it. The portability library components 100 may have information to be communicated to the presentation and styling section 56, application core 54, or visual styling library 58. They perform this by issuing ‘callback’ requests to the portability layer 60. In turn the portability layer 60 will communicate the desired information to the presentation and styling section 56, application core 54, or visual styling library 58 as appropriate.

The application program 54 which gave rise to the function call does not know whether that call is implemented on code which comes from the native library 62 or the special portability library 64. The hardware target platform 70 may include any type of processor such as an X86 or Pentium (RTM) or PowerPC (RTM) set top box running any type of operating system such as the Linux (RTM) or pSOS operating system. Each of the target platforms has associated with it some target specific software code to implement the generic facilities required of it. For example, these may include the facilities necessary to provide memory management, timers, screen update, network access, keyboard input, mouse input, and local filing system. These are different for each of the two example target platforms. Feature-rich platforms may have many such facilities available but feature-sparse platforms may have none or few such facilities available in this way. For each of two application cores 54A and 54B, namely web browser and e-mail respectively, two different visual product styling and user interface logic designs are implemented. One may be directed to sophisticated and experienced users, for example, and the other at inexperienced and less sophisticated users. The latter may for instance be provided with a simpler set of facilities and more colourful graphics.

The system described make it possible to transport the application program to run on a different platform very rapidly as the only changes to be made are in the assembly of the portability library 90. The application program itself is platform independent. The systems work with both feature-rich and feature-sparse operating systems native libraries, simply by selecting features from the special library 64 when those features are not provided by the native library 62, but by using the native library features that are present.

1. A computer system, comprising:
computer hardware including a processor;
an operating system running on the computer hardware;
an application program running on the operating system and making calls to the operating system; and
a library between the application program and the operating system, the library including a plurality of components responsive to function calls from the application program, and
wherein the library comprises components defined by a native library associated with the operating system and other components defined by a special portability library associated with the application.

2. A computer system according to claim 1, further comprising a presentation and styling section which determined the appearance of a displayed output of the application program.

3. A computer system according to claim 1, in which the special portability library includes components from the following: widget set, window manager, mouse control, networking, font rendering, bitmap plotting, frame buffer management, memory management, timers, debug trace, and images.
